(19) United States
(12) Patent Application Publication
(10) Pub. No.: US 2024/0406706 A1
(43) Pub. Date: Dec. 5, 2024

(54) A METHOD AND APPARATUS FOR HANDLING BUSY INDICATION FOR MUSIM UE

(71) Applicant: Samsung Electronics Co., Ltd., Suwon-si, Gyeonggi-do (KR)

(72) Inventors: Vinay Kumar SHRIVASTAVA, Bangalore (IN); Aby Kanneath ABRAHAM, Bangalore (IN)

(21) Appl. No.: 18/681,499

(22) PCT Filed: Aug. 5, 2022
(86) PCT No.: PCT/KR2022/011660

§ 371 Date: Feb. 5, 2024

(30) Foreign Application Priority Data
Aug. 5, 2021 (IN) 202141035424
Jul. 15, 2022 (IN) 202141035424

(51) Int. Cl. H04W 8/18; H04W 88/06

(52) U.S. Cl. CPC H04W 8/18; H04W 88/06

(57) ABSTRACT

The disclosure relates to a 5G or 6G communication system for supporting a higher data transmission rate. The embodiment herein is to provide a method performed by a multiple subscriber information module user equipment (MUSIM UE) in a wireless communication system. The method includes receiving, from a second network, a paging request on a second SIM in a radio resource control (RRC) inactive state, while receiving service on a first SIM from a first network and in case that the MUSIM UE rejects the paging request, and criteria for transmitting a busy indication is met, transmitting the busy indication to the second network in response to the paging request, and in case that the MUSIM UE rejects the paging request, and the criteria for transmitting the busy indication is met, avoid transmitting the busy indication to the second network in response to the paging request.

### TECHNICAL FIELD

The present disclosure relates to a wireless communication, and more specifically related to a method and apparatus for busy indication for Multi-Subscriber Identity Module (SIM) User Equipment (UE) in a 5th Generation (5G) network (NW). This application is based on and derives the benefit of Indian Provisional Application 202141035424 filed on 5 Aug. 2021 and Indian Complete Application 202141035424 filed on 15 Jul. 2022, the contents of which are incorporated herein by reference.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

The embodiment herein is to provide a method performed by a multiple subscriber information module user equipment (MUSIM UE) in a wireless communication system. The method includes receiving, from a second network, a paging request on a second SIM in a radio resource control (RRC) inactive state, while receiving service on a first SIM from a first network and in case that the MUSIM UE rejects the paging request, and criteria for transmitting a busy indication is met, transmitting the busy indication to the second network in response to the paging request, and in case that the MUSIM UE rejects the paging request, and the criteria for transmitting the busy indication is met, avoid transmitting the busy indication to the second network in response to the paging request.

### Advantageous Effects of Invention

According to the present invention, the user experience is enhanced with efficient paging operation for a MUSIM feature.

### BRIEF DESCRIPTION OF DRAWINGS

The method, the UE and the network device are illustrated in the accompanying drawings, throughout which like reference letters indicate corresponding parts in the various figures. The embodiments herein will be better understood from the following description with reference to the drawings, in which:

FIG. 1 illustrates an overview of a wireless network for handling busy indication for a MUSIM UE associated with a plurality of network devices in the wireless network, according to the embodiments as disclosed herein;

FIG. 2 shows various hardware components of the MUSIM UE, according to the embodiments as disclosed herein;

FIG. 3 shows various hardware components of the network device, according to the embodiments as disclosed herein;

FIG. 4 is a flow chart illustrating a method, implemented by the MUSIM UE, for handling busy indication for the MUSIM UE associated with the plurality of network devices in the wireless network, according to the embodiments as disclosed herein;

FIG. 5 is a flow chart illustrating a method, implemented by the network device, for handling busy indication for the MUSIM UE associated with the plurality of network devices in the wireless network, according to the embodiments as disclosed herein;

FIG. 6 is an example flow chart illustrating a method, implemented by the MUSIM UE, for handling busy indication for the MUSIM UE associated with the plurality of network devices in the wireless network by determining a condition for at least one implementation constraints meeting, according to the embodiments as disclosed herein;

FIG. 7 is an example flow chart illustrating a method, implemented by the MUSIM UE, for sending busy indication for the MUSIM UE associated with the plurality of network devices in the wireless network using a NAS based approach or a AS based approach, according to the embodiments as disclosed herein

FIG. 8-FIG. 11 are example sequence flow diagrams illustrating various step by step operations for handling busy indication for the MUSIM UE associated with the plurality of network devices in the wireless network, according to the embodiments as disclosed herein;

FIG. 12 illustrating a scenario of AS based busy indication approach is employed for RRC_INACTIVE state UEs, according to the embodiments as disclosed herein;

FIG. 13 illustrates an example scenario of a gNB receiving a timer in an NGAP message, according to the embodiments as disclosed herein;

FIG. 14 illustrates an example scenario of a gNB receiving busy indication in an RRC_INACTIVE state, according to the embodiments as disclosed herein;

FIG. 15 is a block diagram of an internal configuration of a base station, according to an embodiment as disclosed herein; and

FIG. 16 is a block diagram showing an internal structure of a terminal, according to an embodiment as disclosed herein.

### BEST MODE FOR CARRYING OUT THE INVENTION

Accordingly, the embodiment herein is to provide a method performed by a multiple subscriber information module user equipment (MUSIM UE) in a wireless communication system. The method includes receiving, from a second network, a paging request on a second SIM in a radio resource control (RRC) inactive state, while receiving service on a first SIM from a first network and in case that the MUSIM UE rejects the paging request, and criteria for transmitting a busy indication is met, transmitting the busy indication to the second network in response to the paging request, and in case that the MUSIM UE rejects the paging request, and the criteria for transmitting the busy indication is met, avoid transmitting the busy indication to the second network in response to the paging request.

In an embodiment, the MUSIM UE rejects the paging request based on at least one of a processing delay, a processing burden, an interruption gap, a hardware limitation, a capability of the MUSIM UE, a channel condition, a priority of the service being served on the first SIM, and an emergency service.

In an embodiment, the transmitting of the busy indication includes transmitting, to the second network, a RRC resume request message or a RRC resume request 1 message with the resume cause set as the busy indication.

In an embodiment, the transmitting of the busy indication includes transmitting, to the second network, a service request message including a indication for rejecting the paging request.

In an embodiment, the MUSIM UE transmits a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

Accordingly, the embodiment herein is to provide a method performed by a base station in a wireless communication system. The method includes transmitting, to a multiple subscriber information module user equipment (MUSIM UE), a paging request on a second SIM in a radio resource control (RRC) inactive state via a second network, while the MUSIM UE is receiving a service on a first SIM from a first network, receiving, from the MUSIM UE, a busy indication in response to the paging request and stop transmitting the paging request in response to receiving the busy indication.

In an embodiment, discarding or buffering packets for a predetermined time duration, and performing at least one of: a) retaining the RRC INACTIVE state of the MUSIM UE and resuming the paging request, b) transmitting a RRC release message to the MUSIM UE, c) implicitly transiting a RRC state of the MUSIM UE to a RRC IDLE state from the RRC INACTIVE state, or d) transmitting an access network (AN) release signaling to the core network (CN).

In an embodiment, the receiving of the busy indication includes receiving, from the MUSIM UE, a RRC resume request message or a RRC resume request 1 message with the resume cause set as the busy indication, or receiving, from the MUSIM UE, a service request message including a indication for rejecting the paging request.

Accordingly, the embodiment herein is to provide a multiple subscriber information module user equipment (MUSIM UE) in a wireless communication system. The MUSIM UE includes a transceiver configured to transmit or receive a signal and a controller coupled with the transceiver and configured to: receive, from a second network, a paging request on a second SIM in a radio resource control (RRC) inactive state, while receiving service on a first SIM from a first network and in case that the MUSIM UE rejects the paging request, and criteria for transmitting a busy indication is met, transmit the busy indication to the second network in response to the paging request, and in case that the MUSIM UE rejects the paging request, and the criteria for transmitting the busy indication is met, avoid transmitting the busy indication to the second network in response to the paging request.

In an embodiment, the controller is configured to reject the paging request based on at least one of a processing delay, a processing burden, an interruption gap, a hardware limitation, a capability of the MUSIM UE, a channel condition, a priority of the service being served on the first SIM, and an emergency service.

In an embodiment, the controller is configured to transmit, to the second network, a RRC resume request message or a RRC resume request 1 message with the resume cause set as the busy indication.

In an embodiment, the controller is configured to transmit, to the second network, a service request message including a indication for rejecting the paging request.

In an embodiment, the controller is configured to transmit a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

Accordingly, the embodiment herein is to provide a base station in a wireless communication system. The MUSIM UE includes a transceiver configured to transmit or receive a signal and a controller coupled with the transceiver and configured to transmit, to a multiple subscriber information module user equipment (MUSIM UE), a paging request on a second SIM in a radio resource control (RRC) inactive state via a second network, while the MUSIM UE is receiving a service on a first SIM from a first network, receive, from the MUSIM UE, a busy indication in response to the paging request; and stop transmitting the paging request in response to receiving the busy indication.

In an embodiment, the controller is configured to discard or buffer packets for a predetermined time duration, and perform at least one of: a) retaining the RRC INACTIVE state of the MUSIM UE and resuming the paging request, b) transmitting a RRC release message to the MUSIM UE, c) implicitly transiting a RRC state of the MUSIM UE to a RRC IDLE state from the RRC INACTIVE state, or d) transmitting an access network (AN) release signaling to the core network (CN).

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Due to popularity of Multi-SIM (MUSIM) devices that host more than one Subscriber Identity Module (SIM) to have a facility to connect to two or more different network (NWs) in order to avail different data plans, have user profiles like home and office, increased connectivity/reliability with multiple connections etc. In order to save on the cost, Radio Frequency (RF) circuitry used by a User Equipment (UE) is common for multiple SIMs. That implies, multiple SIMs needs to arbitrate and share the common RF resource among them to perform their activities and/or avail services.

Effectively, only one SIM and its associated protocol stack can be served. Meanwhile, all other SIMs and their associated protocol stacks will be waiting for the RF resource to be available for them. One or more of the multiple SIMs can be engaged in paging reception, system information block (SIB) acquisition, measurement, data or voice call, Multimedia broadcast multicast service (MBMS), emergency call, access stratum (AS) signaling, Non-access stratum (NAS) signaling and so on. Some of these operations are periodic like paging and some are aperiodic and/or un-deterministic like signaling. Further, duration required to complete the operation may also be fixed or unpredictable.

Objective should be to ensure the service performance is maintained at best possible level for each of the SIMs in consideration to the kind of activities or services being availed on each SIM/NW. Therefore, when the RF is tuned away to one of the SIM, other SIMs see it as gap and no uplink or downlink data transfer or no other activities like paging reception or measurement operations can be performed in the gap. Basically other SIMs needs to wait through the gap duration to be able to access RF resource again and be operational.

Thus, it is desired to address the above mentioned disadvantages or other shortcomings or at least provide a useful alternative.

Accordingly the embodiment herein is to provide a method for handling busy indication for MUSIM UE associated with a plurality of network devices in a wireless network. The method includes receiving, by the MUSIM UE, a paging request from a second SIM while the MUSIM UE is receiving a service on a first SIM. Further, the method includes determining, by the MUSIM UE, whether a criteria for sending the busy indication is met. Further, the method includes performing, by the MUSIM UE, one of: sending the busy indication to a network device associated with the second SIM as a response to the paging request in response to determining that the criteria for sending the busy indication is met, and avoiding sending of any response to the paging request received from a network device associated with the second SIM in response to determining that the criteria for sending the busy indication is not met.

In conventional methods and systems, where the UE is connected on first SIM to a first network device (i.e., NW A) and receiving certain services/performing certain activities (e.g. a data transfer session or a call) and the UE is also monitoring paging on a second SIM for a second network device (i.e., NW B) in an RRC_IDLE or RRC_INACTIVE state. Considering the priority of the service/activity on the NW A is high, the UE may prefer to avoid responding to paging and/or acting on paging on the NW B in order to ensure service/activity can run smoothly on the NW A. However, there is no proper approach to achieve this. Presently the 3GPP is considering this issue and working on building a solution for this. Particularly, for RRC_INACTIVE state, where the paging is performed by RAN (Radio Access Network) e.g. gNB or base station, there is a need for a procedure to perform busy indication towards the NW B. The proposed method addresses this issue and provide multiple solutions and approaches achieving efficient, robust and well defined performance.

Unlike to the conventional methods and systems, the proposed method describes the methods considering two SIMs for the illustration purpose. However, this does not limit the methods and description for multiple SIM cases e.g. where more than two SIMs are supported like 3 SIMs, 4 SIMs, 5 SIMs, and so on in the same mobile device. Further illustration, description considers one of the SIM in an RRC_CONNECTED state and other SIM in an RRC_INACTIVE. However, the methods and approaches can be extended to other modes/states and combinations thereof. Also, Radio Access Technology of the SIMs can also pertain to others RATs than 5G like second generation (2G), third generation (3G), fourth generation (4G), sixth generation (6G), wireless fidelity (W-FI) and so on and possible combinations thereof. The proposed method describes different approaches which is particularly address the busy indication for RRC_INACTIVE state UEs.

The proposed method can be used to enable the busy indication procedure and implementation for the UE and network device. Hence, the user experience is enhanced with efficient paging operation for the MUSIM feature.

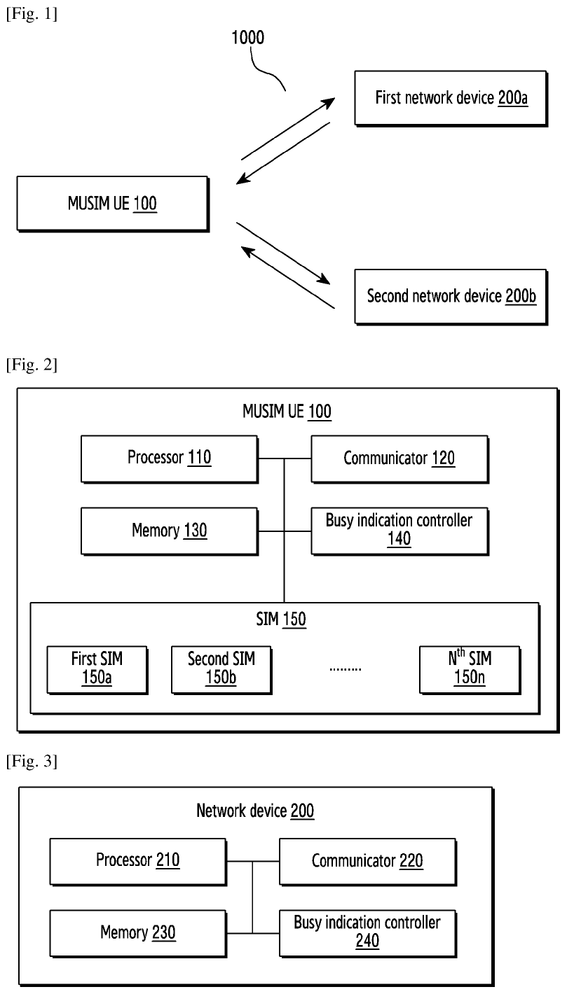

Referring now to the drawings and more particularly to FIGS. 1 through 14, where similar reference characters denote corresponding features consistently throughout the figures, there are shown preferred embodiments.

FIG. 1 illustrates an overview of a wireless network (1000) for handling busy indication for a MUSIM UE (100) associated with a plurality of network devices (200a and 200b) in the wireless network (1000), according to the embodiments as disclosed herein. In an embodiment, the wireless network (1000) includes the MUSIM UE (100) and the plurality of network devices (200a and 200b). The MUSIM UE (100) can be, for example, but not limited to a cellular phone, a smart phone, a Personal Digital Assistant (PDA), a tablet computer, a laptop computer, a television, a connected car, an Internet of Things (IoT), embedded systems, edge devices,

The MUSIM UE (100) receives a paging request from a network device associated with the second SIM (150b) (as shown in the FIG. 2) while the MUSIM UE (100) is receiving a service on the first SIM (150a) (as shown in the FIG. 2). Further, the MUSIM UE (100) determines whether a criteria for sending the busy indication is met. The criteria for sending the busy indication can be, for example, but not limited to a processing delay, a processing burden, an interruption gap, a hardware limitation, a capability of the MUSIM UE (100), channel condition, a priority of the service being served on the first SIM (150a), and an emergency service.

In an embodiment, in response to the paging request in response to determining that the criteria for sending the busy indication is met, the MUSIM UE (100) sends the busy indication to the network device (i.e., consider second network device (200b)) associated with the second SIM (150b).

The MUSIM UE (100) determines whether a criteria for selecting a NAS based approach or an AS based approach is met for sending the busy indication to the network device associated with the second SIM (150b). The criteria selecting a NAS based approach or an AS based approach for sending the busy indication can be, for example, but not limited to a capability of the MUSIM UE (100) to support the NAS based approach or the AS based approach, a need for paging filtering information to send the busy indication, a slice configuration allowing the NAS based approach or the AS based approach, a level of activity on the first SIM (150a) is comparatively higher than a determined level of activity, a priority of the service on the first SIM (150b), a latency requirement, an accepted interruption gap, an implementation not supporting one of the approaches, a specified approach in the 3GPP standard release, and an operator configured approach.

In an embodiment, the MUSIM UE (100) sends the busy indication to the network device associated with the second SIM (150b) using the NAS based approach in response to determining that the criteria for selecting the NAS based approach is met. In an example, the MUSIM UE (100) sends a service request message including a reject paging indication to the network device associated with the second SIM (150b).

In another embodiment, the MUSIM UE (100) sends the busy indication to the network device associated with the second SIM (150b) using the AS based approach in response to determining that the criteria for selecting the AS based approach is met. In another example, the MUSIM UE (100) sends a RRC resume request message or a RRC resume request1 message with resume cause as the busy indication to the network device associated with the second SIM (150b).

Alternately, in response to determining that the criteria for sending the busy indication is not met, the MUSIM UE (100) avoids sending any response to the paging request received from the second SIM (150b).

Further, the network device (200) sends the paging request while the MUSIM UE (100) is receiving the service on the first SIM (150a) and receives the busy indication from the MUSIM UE (100). In response to receiving the busy indication from the MUSIM UE (100), the network device (200) discards or buffers packets for a pre-specified time duration and stop sending the paging request. The packets are related to at least one of NAS signaling received from the Core Network (CN) and downlink traffic coming from the User Plane Function (UPF).

In an embodiment, the network device (200) initiates a timer in response to receiving the busy indication from the MUSIM UE (100) and discards or buffer the packets for the pre-specified time duration and stop sending the paging request while the timer is running. Further, the network device (200) performs at least one of retain a RRC INACTIVE state of the MUSIM UE (100) and resuming the paging request, move the UE to a RRC IDLE state from the RRC INACTIVE state by sending a RRC Release message to the MUSIM UE (100), implicitly move the UE to a RRC IDLE state from a RRC INACTIVE state when the timer is elapsed, and send a AN release signaling to a CN.

FIG. 2 shows various hardware components of the MUSIM UE (100), according to the embodiments as disclosed herein. In an embodiment, the MUSIM UE (100) includes a processor (110), a communicator (120), a memory (130), a busy indication controller (140) and a plurality of SIMs (150a-150n). The processor (110) is coupled with the communicator (120), the memory (130) and the busy indication controller (140).

The busy indication controller (140) receives the paging request from the second SIM (150b) while the MUSIM UE (100) is receiving the service on the first SIM (150a). The busy indication controller (140) determines whether the criteria for sending the busy indication is met. In an embodiment, the busy indication controller (140) sends the busy indication to the network device associated with the second SIM (150b) as a response to the paging request in response to determining that the criteria for sending the busy indication is met. In an embodiment, the busy indication controller (140) determines whether the criteria for selecting the NAS based approach or the AS based approach is met for sending the busy indication to the network device associated with the second SIM (150b). Further, the busy indication controller (140) performs one of sends the busy indication to the network device associated with the second SIM (150b) using the NAS based approach in response to determining that the criteria for selecting the NAS based approach is met, and sends the busy indication to the network device associated with the second SIM (150b) using the AS based approach in response to determining that the criteria for selecting the AS based approach is met.

In another embodiment, the busy indication controller (140) avoids sending any response to the paging request received from the second SIM (150b) in response to response to determining that the criteria for sending the busy indication is not met.

The busy indication controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the MUSIM UE (100) but it is to be understood that other embodiments are not limited thereon. In other embodiments, the MUSIM UE (100) may include less or more number of components. Further, the labels or names of the components are used only for illustrative purpose and does not limit the scope of the invention. One or more components can be combined together to perform same or substantially similar function in the MUSIM UE (100).

FIG. 3 shows various hardware components of the network device (200), according to the embodiments as disclosed herein. In an embodiment, the network device (200) includes a processor (210), a communicator (220), a memory (230) and a busy indication controller (240). The processor (210) is coupled with the communicator (220), the memory (230) and the busy indication controller (240).

The busy indication controller (240) sends the paging request while the MUSIM UE (100) is receiving the service on the first SIM (150a) and receives the busy indication from the MUSIM UE (100). In an embodiment, the busy indication controller (240) receives the service request message including the reject paging indication from the MUSIM UE (100).

Further, the busy indication controller (240) discards or buffers the packets for the pre-specified time duration and stop sending the paging request in response to receiving the busy indication from the MUSIM UE (100). In an embodiment, the busy indication controller (240) initiates a timer in response to receiving the busy indication from the MUSIM UE (100) and discards or buffers the packets for a pre-specified time duration and stop sending the paging request while the timer is running. Further, the busy indication controller (240) performs at least one of retains a RRC INACTIVE state of the MUSIM UE (100) and resuming the paging request, moves the UE to a RRC IDLE state from the RRC INACTIVE state by sending a RRC Release message to the MUSIM UE (100), implicitly moves the UE (100) to a RRC IDLE state from a RRC INACTIVE state when the timer is elapsed, and sends a AN release signaling to a CN.

The busy indication controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the network device (200) but it is to be understood that other embodiments are not limited thereon. In other embodiments, the network device (200) may include less or more number of components. Further, the labels or names of the components are used only for illustrative purpose and does not limit the scope of the invention. One or more components can be combined together to perform same or substantially similar function in the network device (200).

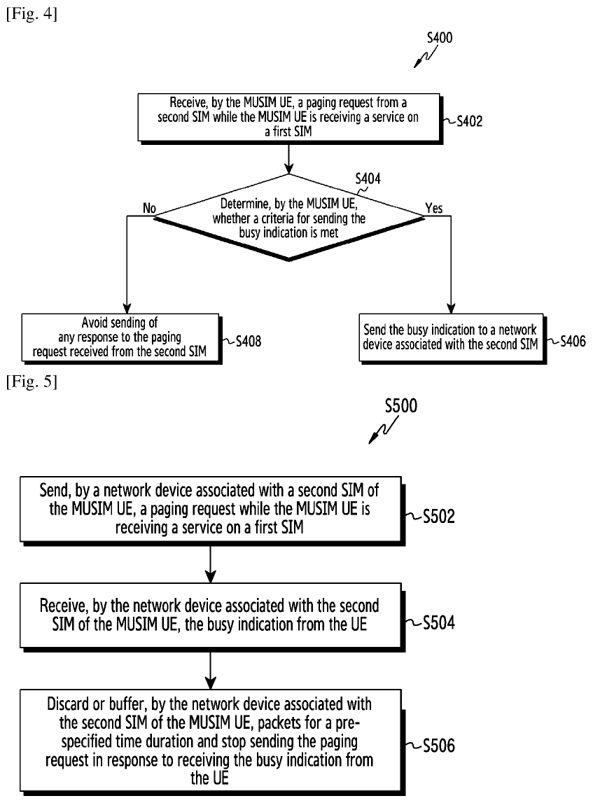

FIG. 4 is a flow chart (S400) illustrating a method, implemented by the MUSIM UE (100), for handling busy indication for the MUSIM UE (100) associated with the plurality of network devices (200a and 200b) in the wireless network (1000), according to the embodiments as disclosed herein. The operations (S402-S408) are handled by the busy indication controller (140).

At S402, the method includes receiving the paging request from the second SIM (150b) while the MUSIM UE (100) is receiving a service on a first SIM (150a). At S404, the method includes determining whether the criteria for sending the busy indication is met. In a response to the paging request in response to determining that the criteria for sending the busy indication is met, at S406, the method includes sending the busy indication to the network device associated with the second SIM (150b). In response to response to determining that the criteria for sending the busy indication is not met, at S408, the method includes avoiding sending of any response to the paging request received from the network device associated with the second SIM (150b).

FIG. 5 is a flow chart (S500) illustrating a method, implemented by the network device (200), for handling busy indication for the MUSIM UE (100) associated with the plurality of network devices (200a and 200b) in the wireless network (1000), according to the embodiments as disclosed herein. The operations (S502-S506) are handled by the busy indication controller (240)

At S502, the method includes sending the paging request while the MUSIM UE (100) is receiving the service on the first SIM (150a). At S504, the method includes receiving the busy indication from the MUSIM UE (100). At S506, the method includes discarding or buffering packets for the pre-specified time duration and stop sending the paging request in response to receiving the busy indication from the MUSIM UE (100).

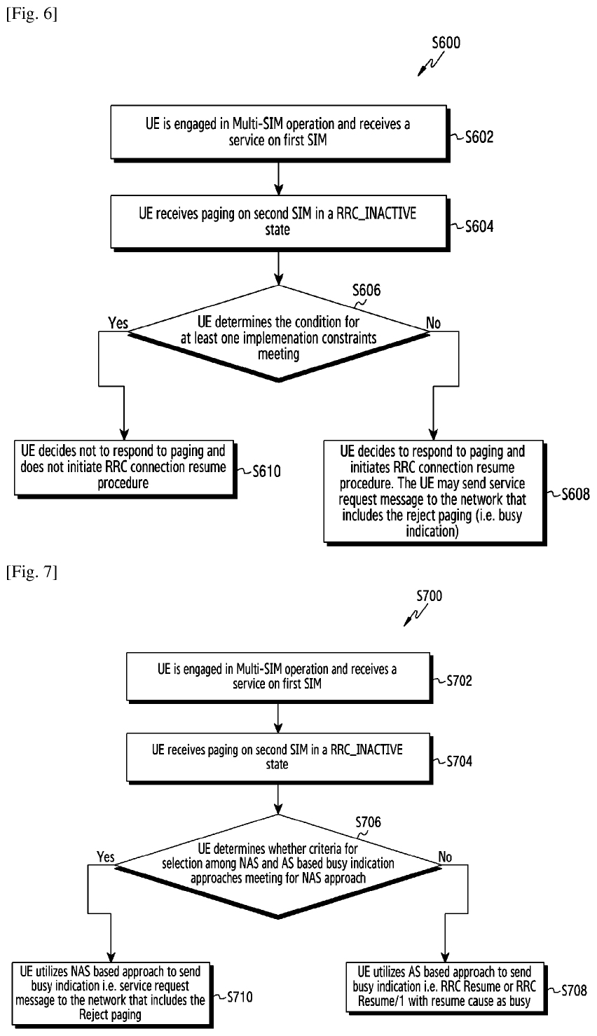

FIG. 6 is a flow chart (S600) illustrating a method, implemented by the MUSIM UE (100), for handling busy indication for the MUSIM UE (100) associated with the plurality of network devices (200a and 200b) in the wireless network (1000) by determining the condition for at least one implementation constraints meeting, according to the embodiments as disclosed herein. The implementation constraints may include at least one of processing delay, processing burden, interruption gap, hardware limitation, UE capability, channel conditions, priority of service being served, and the emergency service.

At S602, the UE (100) is engaged in the multi-SIM operation and receives the service on the first SIM (150a). At S604, the UE (100) receives the paging on the second SIM (150b) in the RRC_INACTIVE state. At S606, the UE (100) determines the condition for at least one implementation constraints meeting. In response to the condition for at least one implementation constraints meets than, at S608, the UE (100) decides not to respond to paging and initiates RRC connection resume procedure. The UE (100) may send service request message to the network that includes the reject paging indication (i.e., busy indication). In response to the condition for at least one implementation constraints does not meet than, At S610, the UE (100) decides to respond to paging and does not initiate RRC connection resume procedure.

FIG. 7 is a flow chart (S700) illustrating a method, implemented by the MUSIM UE (100), for handling busy indication for the MUSIM UE (100) associated with the plurality of network devices (200a and 200b) in the wireless network (1000) using the NAS based approach or the AS based approach, according to the embodiments as disclosed herein

At S702, the MUSIM UE (100) is engaged in the multi-SIM operation and receives a service on the first SIM. At S704, the MUSIM UE (100) receives the paging on the second SIM (150b) in the RRC_INACTIVE state. At S706, MUSIM UE (100) determines whether the criteria for selection among NAS and AS based busy indication approaches meets for NAS approach. The criteria may be at least one of UE capability to support NAS based approach, need for paging filtering information to send, Slice configuration allowing NAS based approach, lesser activity level on first SIM, priority of service on first SIM, higher latency requirement, accepted interruption gap, specified approach in 3GPP standards release, and the operator configured approach. If the criteria for selection among NAS and AS based busy indication approaches meets for AS approach (or does not meet for NAS approach), at S708, the MUSIM UE (100) utilizes the AS based approach to send busy indication i.e., RRC resume or RRC Resume/1 with resume cause as busy. If the criteria for selection among NAS and AS based busy indication approaches meets for the NAS approach, at S710, the MUSIM UE (100) utilizes NAS based approach to send busy indication i.e., the service request message to the network that includes the reject paging indication.

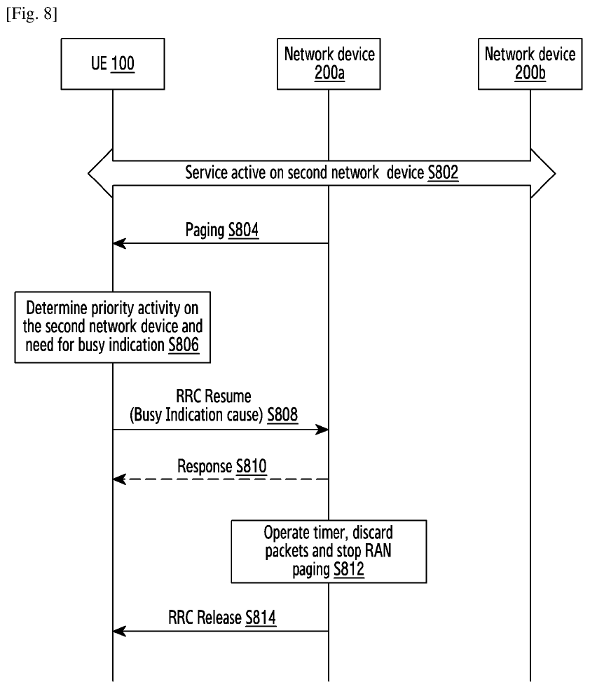

FIG. 8-FIG. 11 are example sequence flow diagrams illustrating various step by step operations for handling busy indication for the MUSIM UE (100) associated with the plurality of network devices (200a and 200b) in the wireless network (1000), according to the embodiments as disclosed herein

As shown in the FIG. 8, at S802, the UE (100) performs the service on the second network device (200b). At S804, the first network device (200a) sends the paging request with the UE (100). At S806, the UE (100) determines the priority activity on the second network device (200b) and needs for busy indication. At S808, the UE (100) sends the RRC resume (including the busy indication cause) to the first network device (200a). At S810, the first network device (200a) sends a response to the UE (100). At S812, the first network device (200a) operates the timer, discards packets and stops the RAN paging. At S814, the first network device (200a) sends a RRC release message to the UE (100).

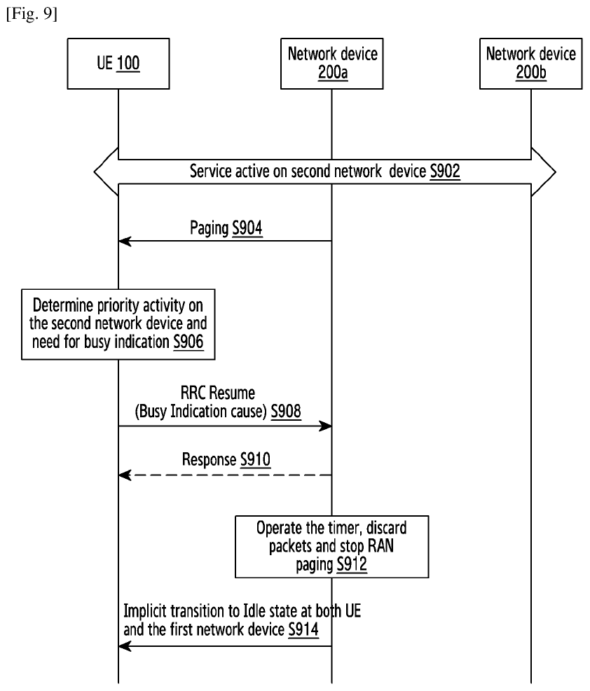

As shown in the FIG. 9, at S902, the UE (100) performs the service on the second network device (200b). At S904, the first network device (200a) sends the paging request with the UE (100). At S906, the UE (100) determines the priority activity on the second network device (200b) and needs for busy indication. At S908, the UE (100) sends the RRC resume (including the busy indication cause) to the first network device (200a). At S910, the first network device (200a) sends a response to the UE (100). At S912, the first network device (200a) operates the timer, discards packets and stops the RAN paging. At S914, the first network device (200a) performs an implicit transition to an idle state at both UE (100) and the first network device (200a).

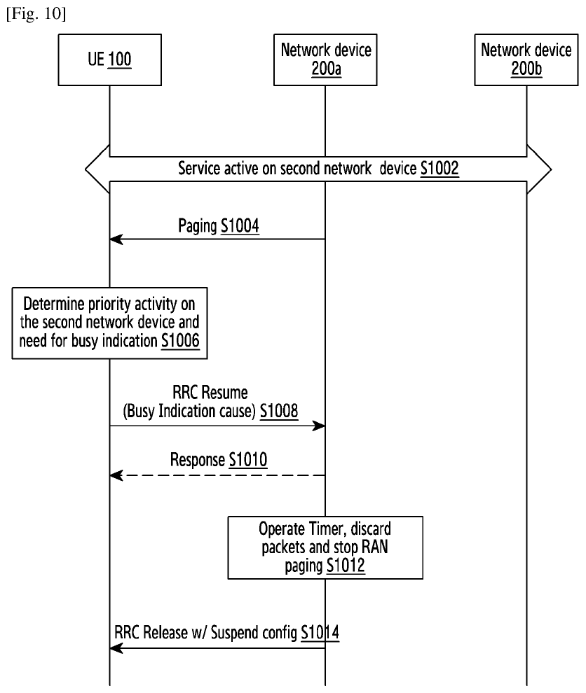

As shown in the FIG. 10, at S1002, the UE (100) performs the service on the second network device (200b). At S1004, the first network device (200a) sends the paging request with the UE (100). At S1006, the UE (100) determines the priority activity on the second network device (200b) and needs for busy indication. At S1008, the UE (100) sends the RRC resume (including the busy indication cause) to the first network device (200a). At S1010, the first network device (200a) sends a response to the UE (100). At S1012, the first network device (200a) operates the timer, discards packets and stops the RAN paging. At S1014, the first network device (200a) sends the RRC Release w/Suspend Config to the UE (100).

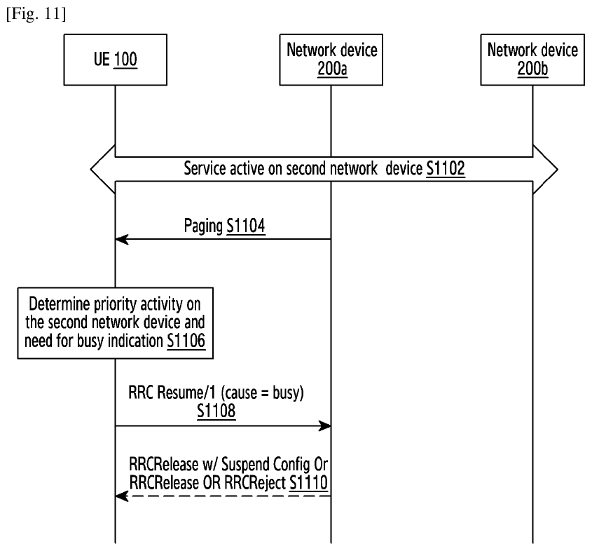

As shown in the FIG. 11, at S1102, the UE (100) performs the service on the second network device (200b). At S1104, the first network device (200a) sends the paging request with the UE (100). At S1106, the UE (100) determines the priority activity on the second network device (200b) and needs for busy indication. At S1108, the UE (100) sends RRC Resume/1 (cause=busy) to the first network device (200a). At S1110, the first network device (200a) sends RRC Release w/Suspend Config or RRCRelease OR RRCReject to the UE (100).

Referring to the FIG. 11 consider a proposed method, on receiving the busy indication, the gNB may move the UE to RRC_IDLE state by sending RRCRelease or RRCRelease with suspend config or RRCReject message. The gNB may also release the connection with the Core network by initiating AN release procedure. This approach doesn't require any timer or packet discard or specific signaling for busy indication to CN.

In another embodiment, the gNB responds to the busy indication from the UE (100) with the RRCRelease or RRCRelease with suspendConfig or RRCReject message. The UE (100) performs paging reception on the NW B as usual in spite of busy indication. That is, the UE (100) monitors PO per DRX cycle, and checks whether there is RAN paging applied to UE. gNB may choose whether to retry to send RAN paging, which can be associated with old data (related with busy indication) or send RAN paging associated with new packet arrived at gNB.

In yet another approach, the RRC_INACTIVE UE sends a NAS message to the AMF to indicate that it is busy and it can't accept the page. The UE sends RRC Resume/Resume1 message and requests gNB to move to RRC_CONNECTED state. On being connected, the UE sends a NAS service request with a specific cause value to indicate that the UE is busy and it can't accept the downlink communication. Instead of NAS service request, any other NAS message might be also send, for instance with a specific cause value. AMF will initiate UE context release procedure to release the UE. The gNB may forward the packets received from the core network to the UE during the time interval between moving to RRC_CONNECTED and RRC release. The UE may drop the received packets.

In another approach, an RRC_INACTIVE UE decides to send busy indication by one of AS or NAS based on one or more factors. For example, it could be based on the UE capability to support either AS or NAS busy indication. Some UEs might be capable of sending only one of AS based or NAS based busy Indication. This also may depend on the properties of the RRC Connected NW-A, while some slices are activated in NW-A, UE might be able to send NAS based busy indication while for some slices, the UE might send only AS based busy indication. This is because NAS based busy indication may have higher latency and the specific slice in NW-A might not be able to allow such a delay.

The UE may also consider the activity level in the connected NW-A before selecting the type of busy indication. For example, if the activity level is less, the UE may decide to send NAS based busy indication since a larger gap could be acceptable. Similarly, if the current activities can accept being away from RRC Connected even for a short while, the UE may send a NAS based busy indication—For e.g. If a file download is ongoing, the UE may prefer to send AS based busy indication since a break in the RRC connection may lead to the download getting aborted.

The UE (100) also may decide between AS or NAS based approach based on the information to convey, e.g. if there is a NAS information to be sent to the network like paging filtering, time needed to return back to the network after paging etc. The UE may decide to send a NAS busy indication, while the message is a plain busy indication without any specific information to the core network, the UE may decide to send AS based busy indication.

In an embodiment, the UE (100) selects between AS or NAS based busy indications or may decide not to send a busy indication based on the type of paging. For e.g. if the paging cause is VoNR or data paging, UE may decide to send a AS based busy indication while for the paging cause is VoLTE, the UE (100) may send NAS based busy indication. For emergency services, the UE (100) may decide not to send the busy indication at all. In another embodiment, the UE (100) may use the service priority for deciding the busy indication type. Service priority could be preconfigured in the USIM or device or might be configured by the network. For e.g., the UE may be configured with a number of slices and each slice may be associated with a priority. The UE may receive slice information like priority in the paging message also. The UE may consider this priority for deciding between whether to send AS or NAS busy indication.

The UE (100) might be also having a number of implementation constraints which may restrict whether the busy indication is sent or how the busy indication is send. For example, UE in the RRC_INACTIVE state may decide to not respond to paging request with busy indication when process of sending busy indication is not realizable because of the implementation constraints. Further, for example, if the RRC_INACTIVE state UE is running a timer like T310 for radio link failure detection, it may not be able to switch the RF for a longer time and may decide to send only AS based busy indication. The implementation constraints may include but not limited to processing delay, processing burden, interruption, hardware limitation, UE capability, channel conditions, priority of service being served, emergency service. Also it is possible that UE implementations may support only one of the approaches (e.g. NAS based approach is only supported). Further, different 3GPP standard releases and/or network operator(s) may specify different support/requirement for the busy indication approaches ((e.g. NAS based approach and/or AS based approach) and a complaint UE implements accordingly. Further, sending busy indication may also be dependant whether the UE is capable or not of dual Rx/dual Tx and/or operating one or more activated component carriers in carrier aggregation and/or dual connectivity. For example, if UE is having an available Tx to send out busy indication in dualRx/singleTx and/or dualRx/dualTx configuration, UE may decide to send busy indication, while if the if UE is not having an available Tx to send out busy indication in dualRx/singleTx and/or dualRx/dualTx configuration, UE may decide not to send busy indication in response to paging request.

In another example, the UE (100) might be performing handover or conditional handover or might have send RACH preamble and waiting for random access response and it may decide to send AS based busy indication only.

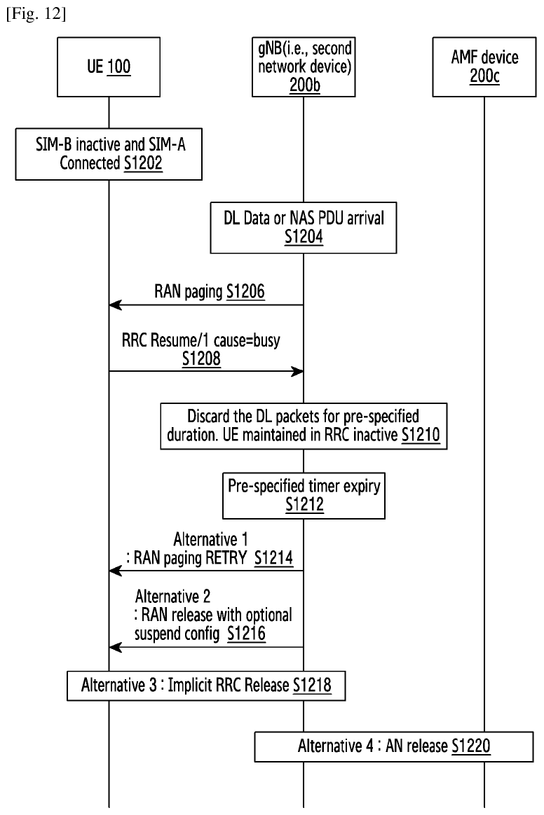

FIG. 12 illustrating a scenario of AS based busy indication approach is employed for RRC_INACTIVE state UEs, according to the embodiments as disclosed herein.

Referring to the FIG. 12 consider a proposed method, the steps are as follows—

1. The UE determines the priority of the service or activity on NW A as comparatively higher than that on NW B and decides to indicate a busy indication to the NW B in response to the RAN paging received on NW B. The UE sends busy indication via RRCResumeRequest/1 on NW B. This provides for a fast approach and minimizes any adverse interruption impact on ongoing service on NW A. UE calculates resume MAC-I using the integrity algorithm (NIA or EIA) in the stored AS context and includes it in RRCResumeRequest/1, new resume cause for indicating busy indication is used.

2. Once UE indicates busy indication via RRCResumeRequest/1, gNB starts discarding packet, if any, received from Core Network (CN) for pre-specified time duration and maintain the UE in RRC_INACTIVE state. RAN paging is not provided to UE. These packets can be PDUs related to NAS signaling and/or packets coming from User Plane Function (UPF). For this purpose, gNB maintains a pre-specified or pre-configured timer. In another alternative, gNB does not discard packet but keeps buffering the packets. In another alternative, gNB informs or notifies the CN about busy indication and/or busy duration.

3. Post the afore-mentioned duration, at least one of the following operations can be performed:
a. gNB retains the RRC_INACTIVE state of UE and resumes RAN paging. UE returns back to page monitoring and/or another busy indication signaling
b. gNB moves the UE to RRC_IDLE from RRC_INACTIVE state by sending a RRCRelease message.
c. gNB and UE implicitly moves to RRC_IDLE from RRC_INACTIVE state when the afore-mentioned time duration is elapsed.
d. gNB sends a AN release signaling to the CN (e.g. AMF).

RRC_INACTIVE UE (UE-B) in the MUSIM device quickly returns the shared RF and processing chain to the connected UE (UE-A) after sending RRC Resume/1 request and receiving acknowledgement either at L2 or L3.

The timer could be configured based on the local/operator policies at gNB. The gNB may transfer the same to the UE in any of the RRC message like RRC Reconfiguration/RRC Resume/RRC setup etc. In an embodiment, they timer may be defined based on the type of the traffic—for e.g. a separate timer may be used for NAS PDU or for the data traffic. The timer could be set differently based on whether paging is for data traffic or voice traffic and also based on the technology used for voice (VoNR/VoLTE).

As shown in FIG. 12, at S1202, consider the SIM-B is inactive and the SIM-A is connected with the network device. At S1204, the gNB detects the DL data or NAS PDU arrival. At S1206, the gNB sends the RAN paging to the UE (100). At S1208, the UE (100) sends the RRC Resume/1 cause=busy to the gNB. At S1210, the gNB discards the DL packets for pre-specified duration. The UE (100) is maintained in the RRC inactive state. At S1212, the gNB determines the pre-specified timer expiry. Upon timer expiry, alternative 1: at S1214, the gBN sends a RAN paging retry to the UE (100). Alternative 2, at S1216, the gBN sends the RRC release with optional suspend config to the UE (100). Alternative 3, at S1218, the gNB sends the implicit RRC release to the UE (100). Alternative 4, at S1220, the AN release is performed between the gNB and AMF device.

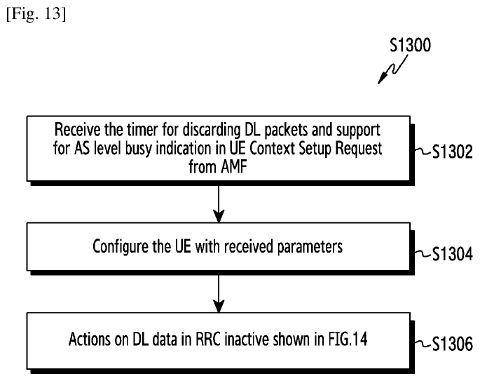

FIG. 13 illustrating a scenario of gNB receive the timer in an NGAP message like UE Context Setup Request, according to the embodiments as disclosed herein.

Referring to the FIG. 13 consider a proposed method, the gNB may receive the timer in an NGAP message like UE Context Setup Request, for e.g. in IEs like CN Assisted RAN Parameters Tuning. The AMF may also provide assistance info on whether Inactive level busy indication is preferred.

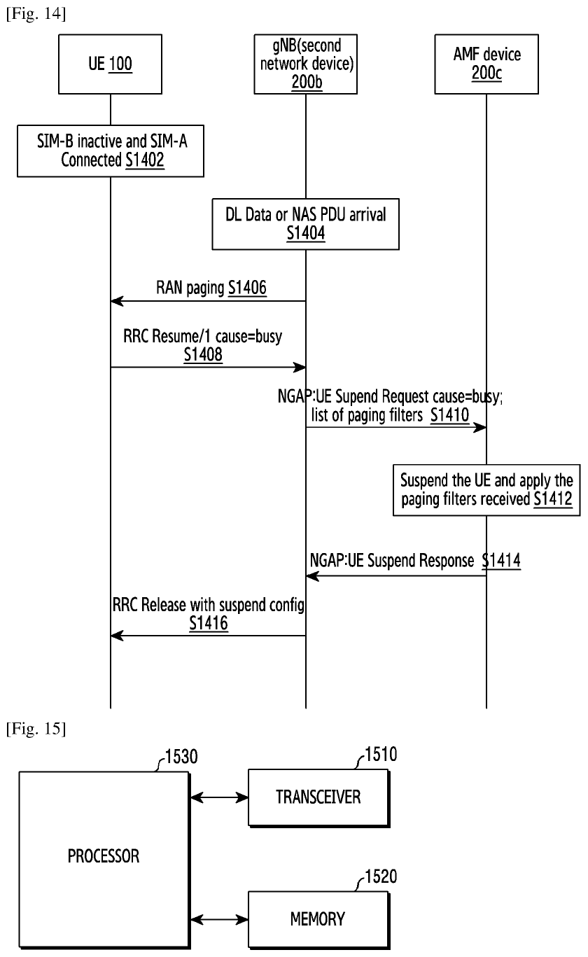

As shown in the FIG. 13, at S1302, the method includes receiving the timer for discarding DL packets and supporting for AS level busy indication in the UE context setup request from the AMF device. At S1304, the method includes configuring the UE with received parameters. At S1306, the method includes performing the actions on DL data in the RRC inactive shown in the FIG. 14.

FIG. 14 illustrating a scenario of gNB receiving busy indication in RRC_INACTIVE state, according to the embodiments as disclosed herein.

Referring to the FIG. 14 consider a proposed method, while receiving busy indication in RRC_INACTIVE state, gNB informs the AMF using an NGAP message like UE Context suspend request. The UE context suspend request can be used for transferring paging filter etc.

Existing RRC transition Report message can be used by gNB to inform AMF about RRC_INACTIVE transition. So the AMF can identify data/NAS message transfer failure can be due to busy indication.

In another embodiment, the RAN paging was initiated for DL NAS message transfer from the AMF, the gNB may send NAS Non delivery report. NAS non delivery report will be sent with a new cause value which indicates that the non-delivery is due to busy indication.

As shown in FIG. 14, at S1402, consider the SIM-B is inactive and SIM-A is connected with the network device. At S1404, the second network device detects the DL data or NAS PDU arrival. At S1406, the gNB sends the RAN paging to the UE (100). At S1408, the UE (100) sends the RRC Resume/1 cause=busy to the gNB. At S1410, the gNB sends the NGAP: UE Suspend Request cause=busy; list of paging filters to the AMF device. At S1412, the AMF device suspends the UE (100) and apply the paging filters received at the AMF device. At S1414, the AMF device (100) sends the NGAP: UE suspend response to the network device. At S1416, the network device sends the RRC release with suspend config to the UE (100).

FIG. 15 is a block diagram of an internal configuration of a base station, according to an embodiment as disclosed herein.

As shown in FIG. 15, the base station according to an embodiment may include a transceiver 1510, a memory 1520, and a processor 1530. The transceiver 1510, the memory 1520, and the processor 1530 of the base station may operate according to a communication method of the base station described above. However, the components of the base station are not limited thereto. For example, the base station may include more or fewer components than those described above. In addition, the processor 1530, the transceiver 1510, and the memory 1520 may be implemented as a single chip. Also, the processor 1530 may include at least one processor.

The transceiver 1510 collectively refers to a base station receiver and a base station transmitter, and may transmit/receive a signal to/from a terminal. The signal transmitted or received to or from the terminal may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the base station. Also, the memory 1520 may store control information or data included in a signal obtained by the base station. The memory 1520 may be a storage medium, such as read-only memory (ROM), random access memory (RAM), a hard disk, a CDROM, and a DVD, or a combination of storage media.

The processor 1530 may control a series of processes such that the base station operates as described above. For example, the transceiver 1510 may receive a data signal including a control signal transmitted by the terminal, and the processor 1530 may determine a result of receiving the control signal and the data signal transmitted by the terminal. The processor may referred to a controller.

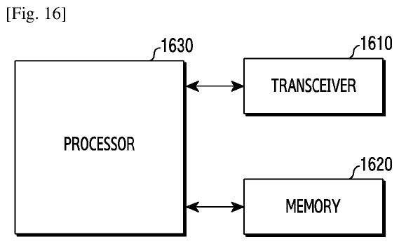

FIG. 16 is a block diagram showing an internal structure of a terminal, according to an embodiment as disclosed herein.

As shown in FIG. 16, the terminal of the present disclosure may include a transceiver 1610, a memory 1616, and a processor 1630. The transceiver 1610, the memory 1616, and the processor 1630 of the terminal may operate according to a communication method of the terminal described above. However, the components of the terminal are not limited thereto. For example, the terminal may include more or fewer components than those described above. In addition, the processor 1630, the transceiver 1610, and the memory 1616 may be implemented as a single chip. Also, the processor 1630 may include at least one processor.

The transceiver 1610 collectively refers to a terminal receiver and a terminal transmitter, and may transmit/receive a signal to/from a base station. The signal transmitted or received to or from the base station may include control information and data. In this regard, the transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1616 may store a program and data required for operations of the terminal. Also, the memory 1616 may store control information or data included in a signal obtained by the terminal. The memory 1616 may be a storage medium, such as ROM, RAM, a hard disk, a CD-ROM, and a DVD, or a combination of storage media.

The processor 1630 may control a series of processes such that the terminal operates as described above. For example, the transceiver 1610 may receive a data signal including a control signal, and the processor 1630 may determine a result of receiving the data signal. The processor may referred to a controller.

Accordingly, the embodiment herein is to provide a method performed by a multiple subscriber information module user equipment (MUSIM UE) in a wireless communication system. The method includes receiving, from a second network, a paging request on a second SIM in a radio resource control (RRC) inactive state, while receiving service on a first SIM from a first network and in case that the MUSIM UE rejects the paging request, and criteria for transmitting a busy indication is met, transmitting the busy indication to the second network in response to the paging request, and in case that the MUSIM UE rejects the paging request, and the criteria for transmitting the busy indication is met, avoid transmitting the busy indication to the second network in response to the paging request.

In an embodiment, the MUSIM UE rejects the paging request based on at least one of a processing delay, a processing burden, an interruption gap, a hardware limitation, a capability of the MUSIM UE, a channel condition, a priority of the service being served on the first SIM, and an emergency service.

In an embodiment, the transmitting of the busy indication includes transmitting, to the second network, a RRC resume request message or a RRC resume request 1 message with the resume cause set as the busy indication.

In an embodiment, the transmitting of the busy indication includes transmitting, to the second network, a service request message including a indication for rejecting the paging request.

In an embodiment, the MUSIM UE transmits a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

Accordingly, the embodiment herein is to provide a method performed by a base station in a wireless communication system. The method includes transmitting, to a multiple subscriber information module user equipment (MUSIM UE), a paging request on a second SIM in a radio resource control (RRC) inactive state via a second network, while the MUSIM UE is receiving a service on a first SIM from a first network, receiving, from the MUSIM UE, a busy indication in response to the paging request and stop transmitting the paging request in response to receiving the busy indication.

In an embodiment, discarding or buffering packets for a predetermined time duration, and performing at least one of: a) retaining the RRC INACTIVE state of the MUSIM UE and resuming the paging request, b) transmitting a RRC release message to the MUSIM UE, c) implicitly transiting a RRC state of the MUSIM UE to a RRC IDLE state from the RRC INACTIVE state, or d) transmitting an access network (AN) release signaling to the core network (CN).

In an embodiment, the receiving of the busy indication includes receiving, from the MUSIM UE, a RRC resume request message or a RRC resume request 1 message with the resume cause set as the busy indication, or receiving, from the MUSIM UE, a service request message including a indication for rejecting the paging request.

Accordingly, the embodiment herein is to provide a multiple subscriber information module user equipment (MUSIM UE) in a wireless communication system. The MUSIM UE includes a transceiver configured to transmit or receive a signal and a controller coupled with the transceiver and configured to: receive, from a second network, a paging request on a second SIM in a radio resource control (RRC) inactive state, while receiving service on a first SIM from a first network and in case that the MUSIM UE rejects the paging request, and criteria for transmitting a busy indication is met, transmit the busy indication to the second network in response to the paging request, and in case that the MUSIM UE rejects the paging request, and the criteria for transmitting the busy indication is met, avoid transmitting the busy indication to the second network in response to the paging request.

In an embodiment, the controller is configured to reject the paging request based on at least one of a processing delay, a processing burden, an interruption gap, a hardware limitation, a capability of the MUSIM UE, a channel condition, a priority of the service being served on the first SIM, and an emergency service.

In an embodiment, the controller is configured to transmit, to the second network, a RRC resume request message or a RRC resume request 1 message with the resume cause set as the busy indication.

In an embodiment, the controller is configured to transmit, to the second network, a service request message including a indication for rejecting the paging request.

In an embodiment, the controller is configured to transmit a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

Accordingly, the embodiment herein is to provide a base station in a wireless communication system. The MUSIM UE includes a transceiver configured to transmit or receive a signal and a controller coupled with the transceiver and configured to transmit, to a multiple subscriber information module user equipment (MUSIM UE), a paging request on a second SIM in a radio resource control (RRC) inactive state via a second network, while the MUSIM UE is receiving a service on a first SIM from a first network, receive, from the MUSIM UE, a busy indication in response to the paging request; and stop transmitting the paging request in response to receiving the busy indication.

In an embodiment, the controller is configured to discard or buffer packets for a predetermined time duration, and perform at least one of: a) retaining the RRC INACTIVE state of the MUSIM UE and resuming the paging request, b) transmitting a RRC release message to the MUSIM UE, c) implicitly transiting a RRC state of the MUSIM UE to a RRC IDLE state from the RRC INACTIVE state, or d) transmitting an access network (AN) release signaling to the core network (CN).

Accordingly, the embodiment herein is to provide a method for handling busy indication for a MUSIM UE associated with a plurality of network devices in a wireless network. The method includes receiving, by the MUSIM UE, a paging request from a second SIM while the MUSIM UE is receiving a service on a first SIM. Further, the method includes determining, by the MUSIM UE, whether a criteria for sending the busy indication is met. Further, the method includes performing, by the MUSIM UE, one of: sending the busy indication to a network device associated with the second SIM as a response to the paging request in response to determining that the criteria for sending the busy indication is met, and avoiding sending of any response to the paging request received from a network device associated with the second SIM in response to determining that the criteria for sending the busy indication is not met.

In an embodiment, the criteria for sending the busy indication comprises at least one of a processing delay, a processing burden, an interruption gap, a hardware limitation, a capability of the MUSIM UE, a channel condition, a priority of the service being served on the first SIM, and an emergency service.

In an embodiment, sending the busy indication to the network device associated with the second SIM includes determining, by the MUSIM UE, whether a criteria for selecting a Non-Access Stratum (NAS) based approach or an Access Stratum (AS) based approach is met for sending the busy indication to the network device associated with the second SIM, and performing, by the MUSIM UE, one of: sending the busy indication to the network device associated with the second SIM using the NAS based approach in response to determining that the criteria for selecting the NAS based approach is met, and sending the busy indication to the network device associated with the second SIM using the AS based approach in response to determining that the criteria for selecting the AS based approach is met.

In an embodiment, the criteria for selecting a NAS based approach or an AS based approach for sending the busy indication comprise at least one of a capability of the UE to support the NAS based approach or the AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation not supporting one of the approaches, a specified approach in the 3GPP standard release, and an operator configured approach.

In an embodiment, sending the busy indication to the network device associated with the second SIM using the NAS based approach comprises sending a service request message including a reject paging indication to the network device associated with the second SIM.

In an embodiment, sending the busy indication to the network device associated with the second SIM using the AS based approach comprises sending a RRC resume request message or a RRC resume request1 message with the resume cause set as the busy indication to the network device associated with the second SIM.

Accordingly, the embodiment herein is to provide a method for handling busy indication for MUSIM UE associated with a plurality of network devices in a wireless network. The method includes sending, by a network device associated with a second SIM of the MUSIM UE, a paging request while the MUSIM UE is receiving a service on a first SIM. Further, the method includes receiving, by the network device associated with the second SIM of the MUSIM UE, the busy indication from the UE. Further, the method includes discarding or buffering, by the network device associated with the second SIM of the MUSIM UE, packets for a pre-specified time duration and stop sending the paging request in response to receiving the busy indication from the UE.

In an embodiment, the packets are related to at least one of NAS signaling from Core Network (CN) and downlink traffic coming from User Plane Function (UPF).

In an embodiment, discarding or buffering the packets for a pre-specified time duration and stop sending the paging request includes initiating, by the network device associated with the second SIM of the MUSIM UE, a timer in response to receiving the busy indication from the UE, discarding or buffering, by the network device associated with the second SIM of the MUSIM UE, the packets for a pre-specified time duration and stop sending the paging request while the timer is running, and performing, by the network device associated with the second SIM of the MUSIM UE, at least one of: retaining a RRC INACTIVE state of the UE and resuming the paging request, moving the UE to a RRC IDLE state from the RRC INACTIVE state by sending a RRC Release message to the UE, implicitly moving the UE to a RRC IDLE state from a RRC INACTIVE state when the timer is elapsed, and sending an Access Network (AN) release signaling to the CN.

In an embodiment, receiving, by the network device associated with the second SIM of the MUSIM UE, the busy indication from the UE comprises receiving a service request message including a reject paging indication from the UE.

In an embodiment, receiving, by the network device associated with the second SIM of the MUSIM UE, the busy indication from the UE comprises receiving a RRC resume request message or a RRC resume request1 message with resume cause set as the busy indication from the UE.

Accordingly, the embodiment herein is to provide a MUSIM UE for handling busy indication in a wireless network. The MUSIM UE includes a busy indication controller communicatively coupled to a memory and a processor. The busy indication controller is configured to receive a paging request from a second SIM while the MUSIM UE is receiving a service on the first SIM. Further, the busy indication controller is configured to determine whether a criteria for sending the busy indication is met. Further, the busy indication controller is configured to perform one of: send the busy indication to a network device associated with the second SIM as a response to the paging request in response to determining that the criteria for sending the busy indication is met, and avoid sending any response to the paging request received from a network device associated with the second SIM in response to determining that the criteria for sending the busy indication is not met.

Accordingly, the embodiment herein is to provide a network device associated with a second SIM of a MUSIM UE for handling busy indication in a wireless network. The network device includes a busy indication controller communicatively coupled to a memory and a processor. The busy indication controller is configured to send a paging request while the MUSIM UE is receiving a service on the first SIM. Further, the busy indication controller is configured to receive the busy indication from the UE and discard or buffer packets for a pre-specified time duration and stop sending the paging request in response to receiving the busy indication from the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the above particular embodiments of the disclosure, the components included in the disclosure are expressed in the singular or plural according to the presented particular embodiments of the disclosure. However, the singular or plural expressions are selected suitably according to the presented situations for convenience of description, the disclosure is not limited to the singular or plural components, and the components expressed in the plural may even be configured in the singular or the components expressed in the singular may even be configured in the plural.

While the disclosure has been shown and described with reference to various embodiments thereof, it will be understood by those skilled in the art that various changes in form and details may be made therein without departing from the spirit and scope of the disclosure as defined by the appended claims and their equivalents.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a multiple subscriber information module user equipment (MUSIM UE) in a wireless communication system, the method comprising:
receiving, from a second network, a paging request on a second SIM in a radio resource control (RRC) inactive state, while receiving service on a first SIM from a first network; and
in case that the MUSIM UE rejects the paging request, and criteria for transmitting a busy indication is met, transmitting the busy indication to the second network in response to the paging request, and
in case that the MUSIM UE rejects the paging request, and the criteria for transmitting the busy indication is met, avoid transmitting the busy indication to the second network in response to the paging request.

2. The method of claim 1, wherein the MUSIM UE rejects the paging request based on at least one of a processing delay, a processing burden, an interruption gap, a hardware limitation, a capability of the MUSIM UE, a channel condition, a priority of the service being served on the first SIM, and an emergency service.

3. The method of claim 1, wherein the transmitting of the busy indication comprises:
transmitting, to the second network, a RRC resume request message or a RRC resume request 1 message with the resume cause set as the busy indication.

4. The method of claim 1, wherein the transmitting of the busy indication comprises:
transmitting, to the second network, a service request message including a indication for rejecting the paging request.

5. The method of claim 1, wherein the MUSIM UE transmits a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

6. A method performed by a base station in a wireless communication system, the method comprising:
transmitting, to a multiple subscriber information module user equipment (MUSIM UE), a paging request on a second SIM in a radio resource control (RRC) inactive state via a second network, while the MUSIM UE is receiving a service on a first SIM from a first network;
receiving, from the MUSIM UE, a busy indication in response to the paging request; and
stop transmitting the paging request in response to receiving the busy indication.

7. The method of claim 6, further comprising:
discarding or buffering packets for a predetermined time duration, and performing at least one of:
a) retaining the RRC INACTIVE state of the MUSIM UE and resuming the paging request,
b) transmitting a RRC release message to the MUSIM UE,
c) implicitly transiting a RRC state of the MUSIM UE to a RRC IDLE state from the RRC INACTIVE state, or
d) transmitting an access network (AN) release signaling to the core network (CN).

8. The method of claim 6, wherein the receiving of the busy indication comprises:
receiving, from the MUSIM UE, a RRC resume request message or a RRC resume request 1 message with the resume cause set as the busy indication, or
receiving, from the MUSIM UE, a service request message including a indication for rejecting the paging request.

9. A multiple subscriber information module user equipment (MUSIM UE) in a wireless communication system, the MUSIM UE comprising:
a transceiver configured to transmit or receive a signal; and
a controller coupled with the transceiver and configured to:
receive, from a second network, a paging request on a second SIM in a radio resource control (RRC) inactive state, while receiving service on a first SIM from a first network; and
in case that the controller rejects the paging request, and criteria for transmitting a busy indication is met, transmit the busy indication to the second network in response to the paging request, and
in case that the controller rejects the paging request, and the criteria for transmitting the busy indication is met, avoid transmitting the busy indication to the second network in response to the paging request.

10. The MUSIM UE of claim 9, wherein the controller is configured to reject the paging request based on at least one of a processing delay, a processing burden, an interruption gap, a hardware limitation, a capability of the MUSIM UE, a channel condition, a priority of the service being served on the first SIM, and an emergency service.

11. The MUSIM UE of claim 9, wherein the controller is configured to: transmit, to the second network, a RRC resume request message or a RRC resume request 1 message with the resume cause set as the busy indication.

12. The MUSIM UE of claim 9, wherein the controller is configured to: transmit, to the second network, a service request message including a indication for rejecting the paging request.

13. The MUSIM UE of claim 9, wherein the controller is configured to transmits a RRC resume request message or a RRC resume request 1 message, or a service request message based on the at least one of a capability of the MUSIM UE to support a NAS based approach or an AS based approach, a need for paging filtering information to send the busy indication, a slice configuration allowing the NAS based approach or the AS based approach, a level of activity on the first SIM is comparatively higher than a determined level of activity, a priority of the service on the first SIM, a latency requirement, an accepted interruption gap, an implementation support, and a predetermined configuration.

14. A base station in a wireless communication system, the MUSIM UE comprising:
a transceiver configured to transmit or receive a signal; and
a controller coupled with the transceiver and configured to:
transmit, to a multiple subscriber information module user equipment (MUSIM UE), a paging request on a second SIM in a radio resource control (RRC) inactive state via a second network, while the MUSIM UE is receiving a service on a first SIM from a first network;
receive, from the MUSIM UE, a busy indication in response to the paging request; and
stop transmitting the paging request in response to receiving the busy indication.

15. The base station of claim 14, wherein the controller is configured to: discard or buffer packets for a predetermined time duration, and perform at least one of:
a) retaining the RRC INACTIVE state of the MUSIM UE and resuming the paging request,
b) transmitting a RRC release message to the MUSIM UE,
c) implicitly transiting a RRC state of the MUSIM UE to a RRC IDLE state from the RRC INACTIVE state, or
d) transmitting an access network (AN) release signaling to the core network (CN).
